(19) United States
(12) Patent Application Publication
(10) Pub. No.: US 2026/0340906 A1
(43) Pub. Date: Oct. 29, 2026

(54) ARTIFICIAL INTELLIGENCE ASSISTED PRODUCTION LINE OPERATION MANUAL GENERATION SYSTEM AND METHOD

(71) Applicant: COMPAL ELECTRONICS, INC., Taipei City (TW)

(72) Inventor: Kai-Yi Chen, Taipei City (TW)

(73) Assignee: COMPAL ELECTRONICS, INC., Taipei City (TW)

(21) Appl. No.: 19/655,669

(22) Filed: Apr. 22, 2026

Related U.S. Application Data
(60) Provisional application No. 63/792,929, filed on Apr. 23, 2025.

(51) Int. Cl. G06T 11/60; G06F 3/0482; G06F 40/166; G06F 40/58; G06V 10/764; G06V 20/52; G10L 15/22; G06V 20/40

(52) U.S. Cl. CPC G06T 11/60; G06F 3/0482; G06F 40/166; G06F 40/58; G06V 10/764; G06V 20/52; G10L 15/22; G06V 20/41; G10L 2015/223

(57) ABSTRACT

An AI-assisted production line operation manual generation system and an AI-assisted production line operation manual generation method are provided. The AI assisted production line operation manual generation system includes a wearable device, an AI image processing module, and an AI information processing module. The wearable device is configured to acquire image data. The AI image processing module is configured to analyze the image data to generate production line operation context information. The AI information processing module is configured to compare the production line operation context information, workstation information, and workstation operation information to classify the image data into at least one of a plurality of workstation information categories, and generate a production line operation manual report. The production line operation manual report includes a plurality of pages, and each of the plurality of pages includes a first area and a second area.

### CROSS-REFERENCE TO RELATED APPLICATION

This application claims the priority benefit of U.S. provisional applications serial no. 63/792,929, filed on Apr. 23, 2025. The entirety of the above-mentioned patent application is hereby incorporated by reference herein and made a part of this specification.

### BACKGROUND

### Technical Field

The present invention relates to a data generation system, and particularly relates to an AI-assisted production line operation manual generation system and an AI-assisted production line operation manual generation method.

### DESCRIPTION OF RELATED ART

In modern manufacturing and industrial production environments, production line operation manuals play an important role in maintaining production quality and operational consistency. As product designs become increasingly complex and manufacturing processes involve numerous steps, establishing detailed and accurate production line operation manuals has become routine work for industrial engineering personnel. Typically, these manuals need to include a large amount of on-site operation images, step descriptions, and related workstation information to provide clear guidance for operators.

### SUMMARY

The present invention provides an AI-assisted production line operation manual generation system and an AI-assisted production line operation manual generation method having automated and highly efficient production line operation manual generation functionality.

The AI-assisted production line operation manual generation system of the present invention includes a wearable device, an AI image processing module, and an AI information processing module. The wearable device is used to acquire image data. The AI image processing module is coupled to the wearable device and is used to analyze the image data to generate production line operation context information. The AI information processing module is coupled to the AI image processing module and is used to compare the production line operation context information, a plurality of workstation information, and a plurality of workstation operation information to classify the image data to at least one of the plurality of workstation information and generate a production line operation manual report. The production line operation manual report includes a plurality of pages, and each of the plurality of pages includes a first region and a second region. The first region is used to display the image data, and the second region is used to display one of the plurality of workstation information and the production line operation context information.

The AI-assisted production line operation manual generation method of the present invention includes the following steps: acquiring image data through a camera of the wearable device; analyzing the image data through the AI image processing module to generate production line operation context information; and comparing the production line operation context information, a plurality of workstation information, and a plurality of workstation operation information through the AI information processing module to classify the image data to at least one of the plurality of workstation information and generate a production line operation manual report. The production line operation manual report includes a first region and a second region, the first region is used to display the image data, and the second region is used to display at least one of the plurality of workstation information and the production line operation context information.

Based on the above, the AI-assisted production line operation manual generation system and method of the present invention may acquire real-time production line operation images through the wearable device and perform image analysis and classification through AI models to generate a production line operation manual report.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an AI-assisted production line operation manual generation system according to an embodiment of the present invention.

FIG. 2 is a flowchart of an AI-assisted production line operation manual generation method according to an embodiment of the present invention.

FIG. 3 is a schematic diagram of an AI-assisted production line operation manual generation system according to another embodiment of the present invention.

FIG. 4 is a flowchart of an AI-assisted production line operation manual generation method according to another embodiment of the present invention.

FIG. 5 is a schematic diagram of an appearance of a wearable device according to an embodiment of the present invention.

FIG. 6 is a schematic diagram of a real-time production line operation image according to an embodiment of the present invention.

FIG. 7 is a schematic diagram of a user editing interface according to an embodiment of the present invention.

FIG. 8 is a schematic diagram of a production line operation manual report according to an embodiment of the present invention.

### DESCRIPTION OF THE EMBODIMENTS

In order to make the content of the present invention more easily understood, the following embodiments are specifically provided as examples that the present invention can indeed be implemented accordingly. In addition, wherever possible, elements/components/steps using the same reference numerals in the drawings and embodiments represent the same or similar parts.

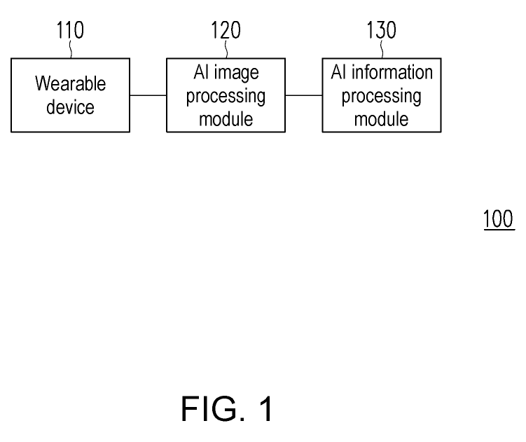

FIG. 1 is a schematic diagram of an AI-assisted production line operation manual generation system according to an embodiment of the present invention. Referring to FIG. 1, the Artificial Intelligence (AI)-assisted production line operation manual generation system 100 includes a wearable device 110, an AI image processing module 120, and an AI information processing module 130. In the present embodiment, the wearable device 110 is coupled to the AI image processing module 120 to output image data to the AI image processing module 120 for image processing. The AI image processing module 120 is coupled to the AI information processing module 130 to output image processing results to the AI information processing module 130 to generate a production line operation manual.

In the present embodiment, the wearable device 110 may be, for example, a head-mounted device or smart glasses, but the present invention is not limited thereto. The AI image processing module 120 and the AI information processing module 130 may be built in a cloud server, and the wearable device 110 may connect to the cloud server through wireless communication, but the present invention is not limited thereto. In one embodiment, the AI image processing module 120 and the AI information processing module 130 may also be built in the wearable device 110, or in a local server, computer device, or workstation.

In one embodiment, the AI image processing module 120 is used to perform “characterize” processing on the original image stream captured by the wearable device 110. The AI image processing module 120 may include, for example, a YOLO real-time object detection model to accurately identify specific components and operation tools on the production line. The AI image processing module 120 may further include, for example, keypoint detection technologies such as MediaPipe or HRNet to track hand movements and trajectories of the user (i.e., operator). The AI image processing module 120 may further include, for example, VideoMAE or related vision transformer models to effectively analyze spatiotemporal correlations in continuous frames, thereby determining the current process state of the user.

In one embodiment, the AI information processing module 130 may include, for example, a large language model with multimodal understanding capabilities (such as GPT-4o or open-source LLaVA), and may be used to stitch fragmented action information into fluent text descriptions that conform to industrial logic. Moreover, to ensure the accuracy and compliance of the generated content, the AI information processing module 130 may further include, for example, Retrieval-Augmented Generation (RAG) technology to interface with the factory’s existing ISO standard or technical specification databases, so that the output operation manual not only has accurate terminology, but also ensures that the sequential order of each work step across multiple workstations complies with engineering safety requirements.

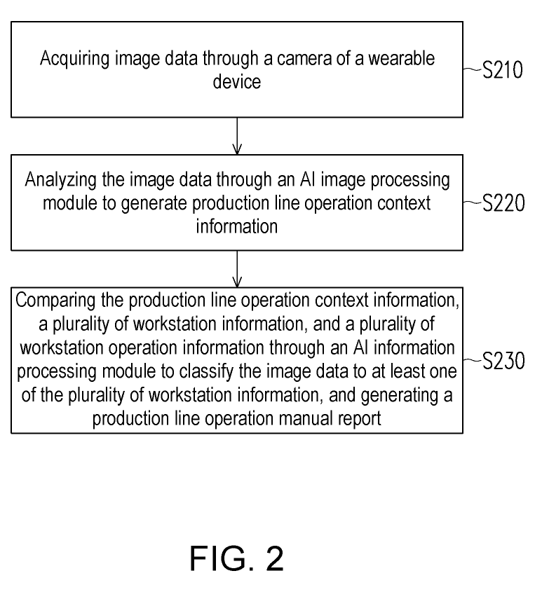

FIG. 2 is a flowchart of an AI-assisted production line operation manual generation method according to an embodiment of the present invention. Referring to FIGS. 1 and 2 , the AI-assisted production line operation manual generation system 100 may execute the following steps S210~S230. In step S210, the wearable device 110 acquires image data. The wearable device 110 may acquire real-time production line operation images and provide image data to the AI image processing module 120. In step S220, the AI image processing module 120 analyzes the image data to generate production line operation context information. The AI image processing module 120 provides the production line operation context information to the AI information processing module 130. In step S230, the AI information processing module 130 compares the production line operation context information, a plurality of workstation information, and a plurality of workstation operation information to classify the image data to at least one of the plurality of workstation information, and generates a production line operation manual report. Therefore, the AI-assisted production line operation manual generation system 100 of the present embodiment may utilize the wearable device 110 to effectively generate a production line operation manual report.

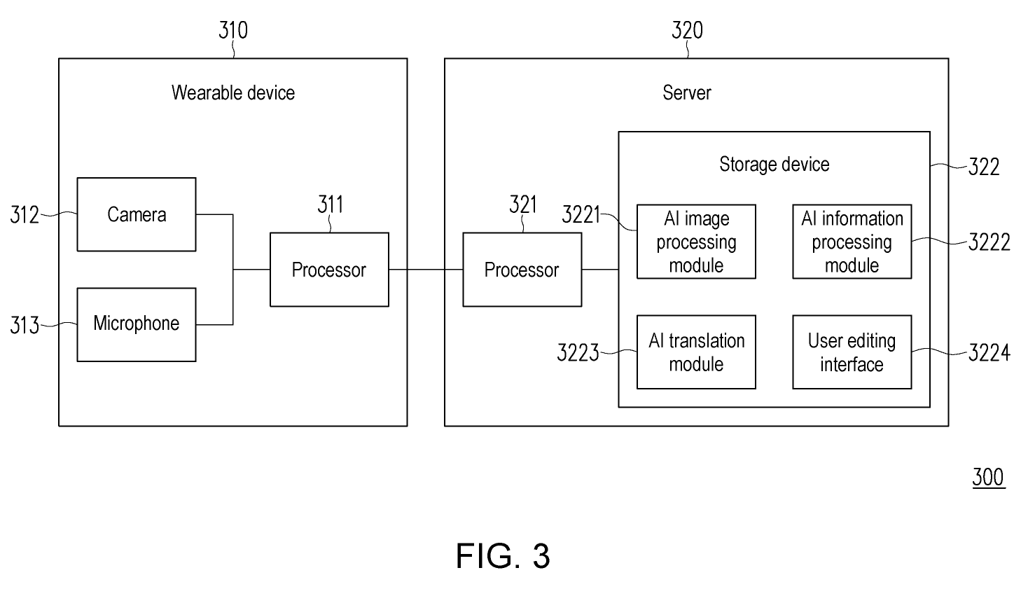

FIG. 3 is a schematic diagram of an AI-assisted production line operation manual generation system according to another embodiment of the present invention. Referring to FIG. 3, in one embodiment, the AI-assisted production line operation manual generation system 300 may include a wearable device 310 and a server 320. The wearable device 310 includes a processor 311, a camera 312, and a microphone 313. The processor 311 is coupled to the camera 312 and the microphone 313. The server 320 includes a processor 321 and a storage device 322. The processor 321 is coupled to the storage device 322. The storage device 322 is used to store an AI image processing module 3221, an AI information processing module 3222, an AI translation module 3223, and a user editing interface 3224. The processor 311 of the wearable device 310 may connect to the server 320 through a wireless communication interface, and the server 320 may include a corresponding wireless communication interface.

In the present embodiment, the processors 311, 321 may respectively include, for example, a Central Processing Unit (CPU), a Graphics Processing Unit (GPU), a Microcontroller (MCU), or other programmable general-purpose or special-purpose microprocessors, a digital signal processors (DSP), a programmable controller, an application specific integrated circuit (ASIC), a programmable logic device (PLD), other similar processing devices, or combinations of these devices.

In the present embodiment, the storage device 322 may include a memory, or may be implemented in the form of a database, wherein the memory may include, for example, a non-volatile memory (NVM), a dynamic random access memory (DRAM), a flash memory, or a non-volatile random access memory (NVRAM).

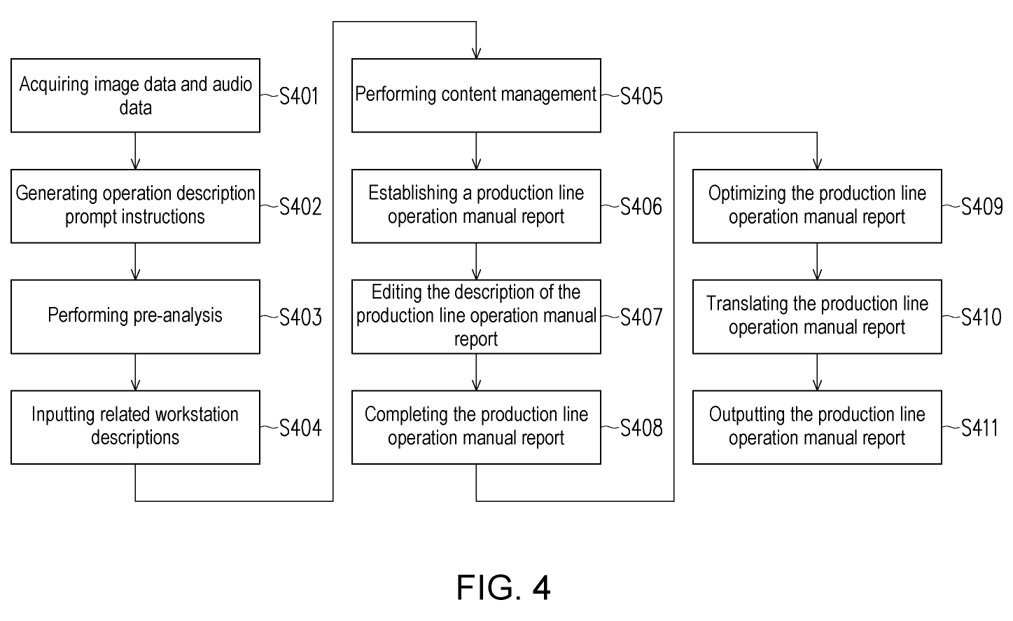

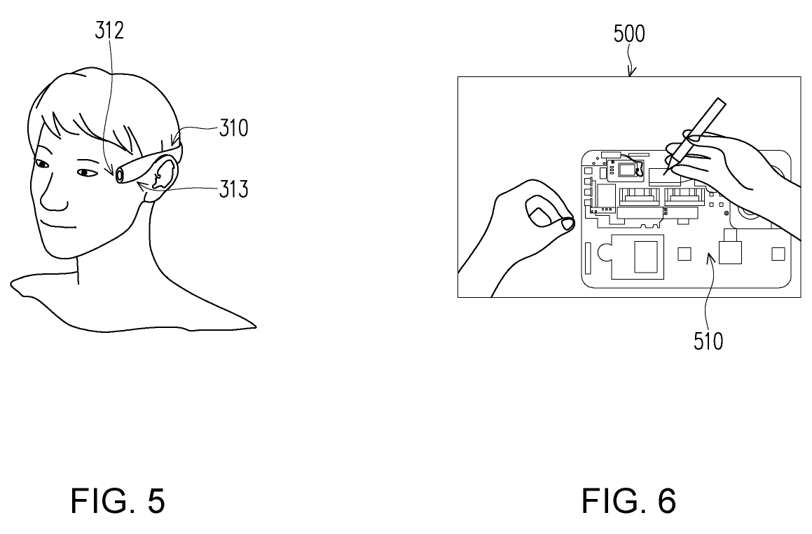

FIG. 4 is a flowchart of an AI-assisted production line operation manual generation method according to another embodiment of the present invention. Referring to FIGS. 3 and 4 , the AI-assisted production line operation manual generation system 300 may execute the following steps S401~S411. In step S401, the wearable device 310 acquires image data and audio data through the camera 312 and the microphone 313. Referring to FIGS. 5,5, is a schematic diagram of the appearance of a wearable device according to an embodiment of the present invention. A user may wear the wearable device 310. The wearable device 310 may be a head-mounted device, wherein the camera 312 may be disposed at one end of the wearable device 310, and the shooting direction of the camera 312 is parallel to the user's line of sight. The microphone 313 may be disposed at one end of the wearable device 310. The wearable device 310 may further include, for example, components such as a laser light source, a speaker component, or a connector, and the present invention is not limited thereto. Referring to FIGS. 6,6, is a schematic diagram of a real-time production line operation image according to an embodiment of the present invention. The camera 312 may capture the user's current viewing content to generate a video display 500 as shown in FIG. 6, wherein the video display 500 includes an object 510. The object 510 is a production line operation target (such as an assembly object) that the user is currently performing. While capturing the video display 500, the user may also issue voice commands (such as voice tags) or related operation content explanations through the microphone 313 to generate corresponding audio data. The voice commands may be, for example, in the form of voice tags for annotating, for example, shooting subjects, special precautions, or assembly precautions.

For example, the audio data may include wake words, action words, connecting words, and/or tag content. The user may, for example, input a voice command “please help me take a photo” through the microphone 313, and the wearable device 310 may generate a corresponding response through a speaker and execute a corresponding action to operate the camera 312 to perform shooting. The user may, for example, input a voice command “this cable will be inserted into the connector until the clip is fixed in place” through the microphone 313 for the AI information processing module 3222 to generate corresponding operation description prompt instructions.

In the present embodiment, the processor 311 of the wearable device 310 may transmit the image data of the video display 500 and the corresponding audio data to the processor 321 of the server 320. The processor 321 may input the image data to the AI image processing module 3221 and input the audio data to the AI information processing module 3222.

In step S402, the AI information processing module 3222 analyzes the audio data to generate operation description prompt instructions. In step S403, the AI image processing module 3221 performs pre-analysis according to the operation description prompt instructions. The AI image processing module 3221 may analyze the image data to generate operation description information in the production line operation context information. In the present embodiment, the AI image processing module 3221 may further crop the image data according to the prompt instructions. In step S404, the user may input related workstation descriptions through the microphone 313 or additional manual input. In step S405, the user may input related information through the camera 312, the microphone 313, or additional manual input to perform content management. In step S406, the processor 321 may establish a production line operation manual report according to each piece of data from the above steps S401 to S405. The processor 321 may perform image cropping and annotate voice tags. Subsequently, the processor 321 may integrate the cropped and voice tag-annotated images with corresponding technical terms and workstation descriptions to automatically classify workstations and organize them into content required for a production line operation manual report of standard operating procedures for production line operations.

For example, the processor 321 may execute the AI information processing module 3222 or other AI models and input the following generation instructions such as: the output format must be a list and presented in three paragraphs, with each paragraph limited to forty characters, focusing on concise narrative. The first paragraph is the main theme, primarily describing the second-level details of what he is doing overall, for example, knowing that he is assembling a computer, but please describe which part he is assembling. The second paragraph describes the details of the event. The third paragraph describes what is special. Please focus on the narrative within the range of the electrostatic plate and ignore anything beyond the electrostatic plate. Only describe the assembly parts and ignore parts beyond assembly, such as ignoring preparation, disassembly, and adjustment. When narrating, please pay special attention to personnel action details, but the subject may be ignored. When narrating, please specifically indicate item details, especially color, direction, connection status, placement status, and upper and lower conditions. After generating the standard operating procedure, please repeatedly check and remove plots that never appeared in these photos. If actual operational behavior is not seen in the screen, such as screwdriver contact, if only screws are seen, screw-tightening plots may not appear.

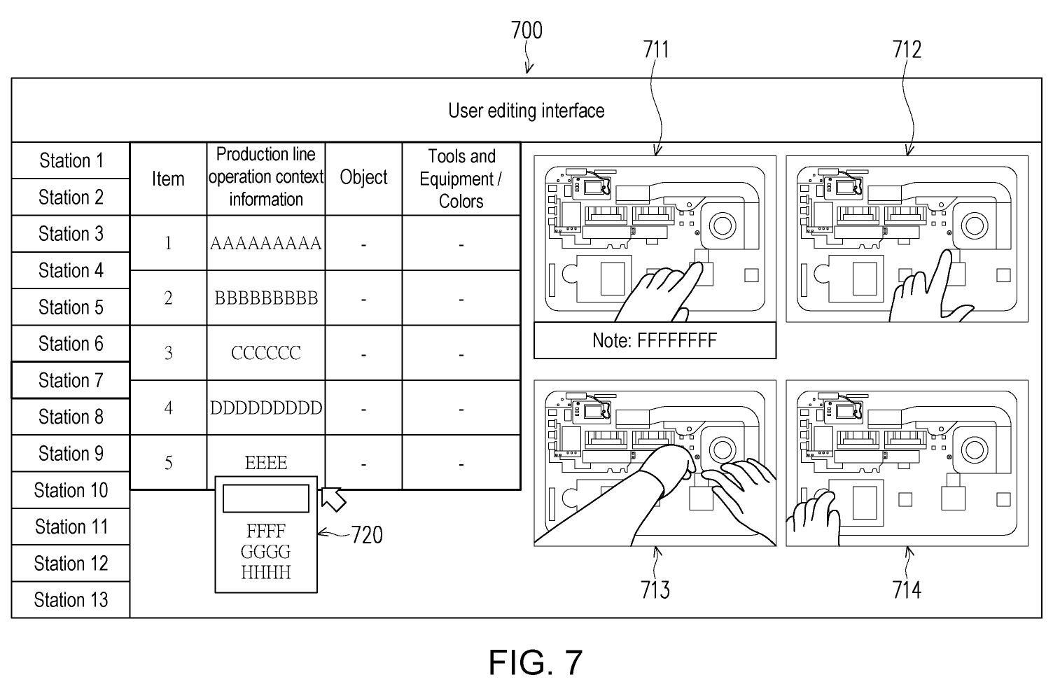

In step S407, the processor 321 may execute the user editing interface 3224 to edit the description of the production line operation manual report. The processor 321 may import all content and perform automatic pagination and workstation layout. Referring to FIGS. 7,7, is a schematic diagram of a user editing interface according to an embodiment of the present invention. The processor 321 may execute the user editing interface 3224 to display a screen 700 as shown in FIG. 7 through a display. The screen 700 includes a plurality of workstation options and a plurality of operation items and production line operation context information records corresponding to each of the workstation options. The screen 700 further includes image data 711~714 of a plurality of captured images. In the present embodiment, the user editing interface 3224 may display the image data and operation description information on the screen 700, and adjust the image data and operation description information according to editing instructions input by the user. The operation description information may be standard operating procedures corresponding to production line operations displayed by the image data.

For example, at least one of the plurality of operation description information shown in FIG. 7 may include technical terms. Taking the production line operation context information “EEEE” having technical terms as an example, the AI information processing module 322 may generate a dropdown menu 720 according to the technical terms, wherein the dropdown menu includes a plurality of replacement options such as “FFFF”, “GGGG”, and “HHHH”. Therefore, the user may conveniently replace the technical terms.

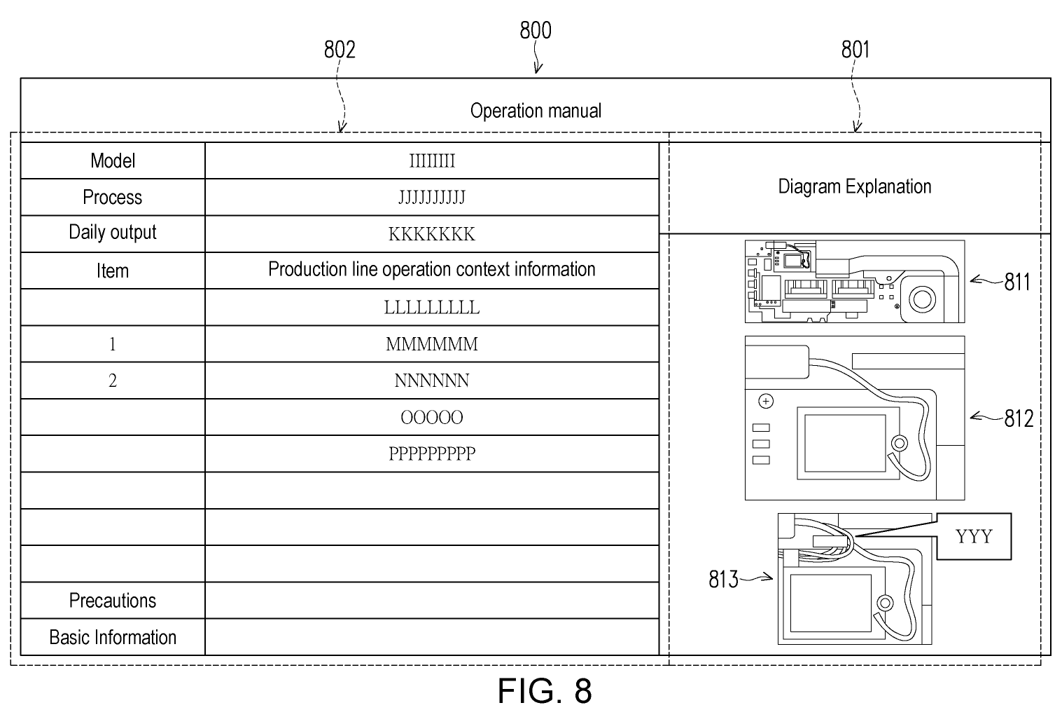

In step S408, the processor 321 completes the production line operation manual report. Referring to FIGS. 8,8, is a schematic diagram of a production line operation manual report according to an embodiment of the present invention. The processor 321 may generate a production line operation manual report 800 as shown in FIG. 8, for example. The production line operation manual report 800 may include a plurality of pages, and each of the plurality of pages may include a first region 801 and a second region 802 as shown in FIG. 8. The first region 801 is used to display image data, and the second region 802 is used to display one of a plurality of workstation information and production line operation context information. The image data includes a plurality of images 811~813, and each of the plurality of pages is used to display different images and corresponding workstation information and corresponding production line operation context information. As shown in FIG. 8, the image 812 may correspond to a plurality of operation description information, for example, and the image 813 may further include annotation information of voice tags previously input by the user through the microphone 313, for example.

In step S409, the processor 321 may optimize the production line operation manual report 800. For example, the production line operation context information may include “pick up black object from table”, and the processor 321 may utilize a preset AI model or connect to a large language model to optimize the description (including technical term adjustment and language conversion) and add special action descriptions as “pick up MLB Holder from work table, visually inspect (magnifier) whether the assembly position of PL sensor’s Rubber CAP is correct”. In step S410, the processor 321 may further selectively execute the AI translation module 3223 to translate the production line operation manual report 800. The AI translation module 3223 may translate the workstation information and the operation description information into specific languages, such as English, Thai, or Vietnamese. In step S411, the processor 321 may output the production line operation manual report 800 to other processing modules, or upload to other servers or databases for recording. The production line operation manual report 800 output by the processor 321 may include, for example, images, text, tags, and video hyperlinks. The production line operation manual report 800 may further be implemented in PDF, EXCEL, or other specific data formats for ease of execution and reading.

In summary, the AI-assisted production line operation manual generation system and method of the present invention may integrate wearable devices and mobile applications to effectively assist industrial engineering (IE) personnel in formulating manufacturing instruction (MI)/standard operating procedure (SOP) that meets actual operational requirements. The AI-assisted production line operation manual generation system and method of the present invention may eliminate redundant processes and reconfigure resources to enhance overall productivity, avoiding repetitive actions and unnecessary processes (such as: photo annotation, content comparison, and workstation section allocation). The AI-assisted production line operation manual generation system and method of the present invention may utilize a generative AI to establish and manage standard operating procedures to ensure that the content is clear, consistent, and scalable (such as immediately generating text according to images, real-time translation, etc.).

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An artificial intelligence (AI)-assisted production line operation manual generation system, comprising:
a wearable device, comprising a camera for acquiring image data;
an AI image processing module, coupled to the wearable device, and configured to analyze the image data to generate production line operation context information; and
an AI information processing module, coupled to the AI image processing module, and configured to compare the production line operation context information, a plurality of workstation information, and a plurality of workstation operation information to classify the image data into at least one of the plurality of workstation information and generate a production line operation manual report,
wherein the production line operation manual report comprises a plurality of pages, and each of the plurality of pages comprises a first region and a second region, the first region is configured to display the image data, and the second region is configured to display one of the plurality of workstation information and the production line operation context information.

2. The AI-assisted production line operation manual generation system according to claim 1, wherein the wearable device further comprises a microphone for acquiring audio data corresponding to the image data, and the AI information processing module analyzes the audio data to generate an operation description prompt instruction,
wherein the AI image processing module analyzes the image data according to the operation description prompt instruction to generate operation description information in the production line operation context information.

3. The AI-assisted production line operation manual generation system according to claim 2, wherein the AI image processing module is further configured to crop the image data according to the prompt instruction.

4. The AI-assisted production line operation manual generation system according to claim 2, wherein the operation description information comprises a technical term, and the AI information processing module generates a dropdown menu according to the technical term, wherein the dropdown menu comprises a plurality of replacement options.

5. The AI-assisted production line operation manual generation system according to claim 2, further comprising:
an AI translation module, coupled to the AI information processing module, and configured to translate the workstation information and the operation description information into a specific language.

6. The AI-assisted production line operation manual generation system according to claim 2, wherein the operation description information is a standard operating procedure corresponding to a production line operation displayed by the image data.

7. The AI-assisted production line operation manual generation system according to claim 2, further comprising:
a user editing interface, configured to display the image data and the operation description information, and adjust the image data and the operation description information according to an editing instruction input by a user.

8. The AI-assisted production line operation manual generation system according to claim 1, wherein the image data comprises a plurality of images, and each of the plurality of pages is configured to display a different image and a corresponding workstation information and a corresponding production line operation context information.

9. The AI-assisted production line operation manual generation system according to claim 1, wherein the wearable device is a head-mounted device, and a shooting direction of the camera is parallel to a line of sight of a user.

10. The AI-assisted production line operation manual generation system according to claim 1, further comprising:
a server having a processor and a storage device, and communicating with the wearable device,
wherein the storage device is configured to store the AI image processing module and the AI information processing module, and the processor is configured to execute the AI image processing module and the AI information processing module.

11. An AI-assisted production line operation manual generation method, comprising:
acquiring image data through a camera of a wearable device;
analyzing the image data through an AI image processing module to generate production line operation context information; and
comparing the production line operation context information, a plurality of workstation information, and a plurality of workstation operation information through an AI information processing module to classify the image data to at least one of the plurality of workstation information, and generating a production line operation manual report,
wherein the production line operation manual report comprises a plurality of pages, and each of the plurality of pages comprises a first region and a second region, the first region is configured to display the image data, and the second region is configured to display at least one of the plurality of workstation information and the production line operation context information.

12. The AI-assisted production line operation manual generation method according to claim 11, further comprising:
acquiring audio data corresponding to the image data through a microphone of the wearable device;
analyzing the audio data through the AI information processing module to generate an operation description prompt instruction; and
analyzing the image data according to the operation description prompt instruction through the AI image processing module to generate operation description information in the production line operation context information.

13. The AI-assisted production line operation manual generation method according to claim 12, further comprising:
cropping the image data according to the prompt instruction through the AI image processing module.

14. The AI-assisted production line operation manual generation method according to claim 12, wherein the operation description information comprises a technical term, and the AI information processing module generates a dropdown menu according to the technical term, wherein the dropdown menu comprises a plurality of replacement options.

15. The AI-assisted production line operation manual generation method according to claim 12, further comprising:
translating the workstation information and the operation description information to a specific language through an AI translation module.

16. The AI-assisted production line operation manual generation method according to claim 12, wherein the operation description information is a standard operating procedure corresponding to a production line operation displayed by the image data.

17. The AI-assisted production line operation manual generation method according to claim 12, further comprising:
displaying the image data and the operation description information through a user editing interface, and adjusting the image data and the operation description information according to an editing instruction input by a user.

18. The AI-assisted production line operation manual generation method according to claim 11, wherein the image data comprises a plurality of images, and each of the plurality of pages is configured to display a different image and workstation information corresponding thereto and production line operation context information corresponding thereto.

19. The AI-assisted production line operation manual generation method according to claim 11, wherein the wearable device is a head-mounted device, and a shooting direction of the camera is parallel to a line of sight of a user.

20. The AI-assisted production line operation manual generation method according to claim 11, wherein the AI image processing module and the AI information processing module are disposed in a storage device of a server and executed by a processor of the server, wherein the server communicates with the wearable device.
